(19) United States
(12) Patent Application Publication
(10) Pub. No.: US 2009/0034581 A1
(43) Pub. Date: Feb. 5, 2009

(54) METHOD FOR HOT PLATE SUBSTRATE MONITORING AND CONTROL

(75) Inventor: MICHAEL CARCASI, Austin, TX (US)

Correspondence Address: TOKYO ELECTRON U.S. HOLDINGS, INC., 4350 W. CHANDLER BLVD., SUITE 10, CHANDLER, AZ, 85226, US

(73) Assignee: Tokyo Electron Limited, Tokyo (JP)

(21) Appl. No.: 11/833,106

(22) Filed: Aug. 2, 2007

(51) Int. Cl. G01K 1/00; G01B 21/00

(52) U.S. Cl. 374/45; 374/141; 374/E01.001

(57) ABSTRACT

Embodiments of methods for improving hot plate substrate monitoring and control in a lithography system are generally described herein. Other embodiments may be described and claimed.

### FIELD OF THE INVENTION

The invention relates to methods and heat treatment apparatus for thermally processing substrates, such as semiconductor substrates.

### BACKGROUND OF THE INVENTION

Photolithography processes for manufacturing semiconductor devices and liquid crystal displays (LCD's) generally coat a resist on a substrate, expose the resist coating to light to impart a latent image pattern, and develop the exposed resist coating to transform the latent image pattern into a final image pattern having masked and unmasked areas. Such a series of processing stages is typically carried out in a coating/developing system having discrete heating sections, such as a pre-baking unit and a post-baking unit. Each heating section of the coating/developing system may incorporate a hotplate with a built-in heater of, for example, a resistance heating type.

Feature sizes of semiconductor device circuits have been scaled to less than 0.1 micron. Typically, the pattern wiring that interconnects individual device circuits is formed with sub-micron line widths. Consequently, the heat treatment temperature of the resist coating should be accurately controlled to provide reproducible and accurate feature sizes and line widths. The substrates or wafers (i.e., objects to be treated) are usually treated or processed under the same recipe (i.e., individual treatment program) in units (i.e., lots) each consisting of, for example, twenty-five substrates. Individual recipes define heat treatment conditions under which pre-baking and post-baking are performed. Substrates belonging to the same lot are heated under the same conditions.

According to each of the recipes, the heat treatment temperature may be varied within such an acceptable range that the temperature will not have an effect on the final semiconductor device. In other words, a desired temperature may differ from a heat treatment temperature in practice. When the substrate is treated with heat beyond the acceptable temperature range, a desired resist coating cannot be obtained. Therefore, to obtain the desired resist coating, a temperature sensor is used for detecting the temperature of the hotplate. On the basis of the detected temperature, the power supply to the heater may be controlled with reliance on feedback from the temperature sensor. It is difficult to instantaneously determine the temperature of the hotplate using a single temperature sensor embedded within the bulk of the hotplate because the temperature of the entire hotplate is not uniform and varies with the lapsed time.

The post exposure bake (PEB) process is a thermally activated process and serves multiple purposes in photoresist processing. First, the elevated temperature of the bake drives the diffusion of the photoproducts in the resist. A small amount of diffusion may be useful in minimizing the effects of standing waves, which are the periodic variations in exposure dose throughout the depth of the resist coating that result from interference of incident and reflected radiation. Another main purpose of the PEB is to drive an acid catalyzed reaction that alters polymer solubility in many chemically amplified resists. PEB also plays a role in removing solvent from the substrate surface.

In addition to the intended results, numerous problems may be observed during heat treatment. For example, the light sensitive component of the resist may decompose at temperatures typically used to remove the solvent, which is a concern for a chemically amplified resist because the remaining solvent content has a strong impact on the diffusion and amplification rates. Also, heat-treating can affect the dissolution properties of the resist and, thus, have direct influence on the developed resist profile. Hotplates having uniformities within a range of a few tenths of a degree centigrade are currently available and are generally adequate for current process methods. Hotplates may be calibrated using a flat bare silicon substrate with imbedded thermal sensors. However, actual production substrates carrying deposited films on the surface of the silicon may exhibit small amounts of warpage because of the stresses induced by the deposited films.

This warpage may cause the normal gap between the substrate and the hotplate (referred to as the proximity gap), to vary across the substrate from a normal value of approximately 100 μm by as much as a 100 μm deviation from the mean proximity gap. Consequently, actual production substrates may have different heating profiles than the substrate used to calibrate the hotplate.

This variability in the proximity gap changes the heat transfer characteristics in the area of the varying gap. Heat transfer through gases with low thermal conductivity, such as air, in the gap can cause temperature non-uniformity across the substrate surface as the temperature of the substrate is elevated to a process temperature. This temperature nonuniformity may result in a change in critical dimension (CD) in that area of several nanometers, which can approach the entire CD variation budget for current leading edge devices, and will exceed the projected CD budget for smaller devices planned for production in the next few years.

### BRIEF DESCRIPTION OF THE DRAWINGS

The present invention is illustrated by way of example and not as a limitation in the accompanying figures.

FIG. 1 is a top view of a schematic diagram of a coating\developing system for use in association with the invention;

FIG. 2 is a front view of the coating/developing system of FIG. 1;

FIG. 3 is a partially cut-away back view of the coating/developing system of FIG. 1;

FIG. 4 is a top view of a heat treatment apparatus for use with the coating/developing system of FIGS. 1-3;

FIG. 5 is a cross-sectional view of the heat treatment apparatus of FIG. 4 generally along line 5-5;

FIG. 6 is an enlarged view of a portion of FIG. 5;

FIG. 7 is an illustration of a flat substrate in contact with support protrusions and a lift pin configured with a temperature sensor; and

FIG. 8 is an illustration of a warped substrate in contact with support protrusions and in close proximity to a lift pin configured with a temperature sensor.

### DETAILED DESCRIPTION

There is a general need for directly monitoring a temperature of a substrate on a hotplate and/or sensing a condition where the substrate is severely warped and/or improperly placed on the hotplate. One way to directly monitor a temperature of a substrate on a hotplate and/or sensing a warped substrate condition or a gross misalignment of the substrate is to incorporate one or more temperature sensing elements in one or more contact points of a substrate placement system. By configuring a substrate placement system with one or more temperature sensing elements, a heat treatment temperature of a substrate, comprising a thin film coating, should be accurately controlled to provide reproducible and accurate feature sizes and line widths.

An embodiment of the method for thermally processing substrates utilizes a coating/developing process system 150. The substrate, generally in the form of a substrate composed of semiconducting material, is processed by the coating/developing process system 150. The processing is accomplished in such a way that the finished product will carry device structures on the top surface of the substrate.

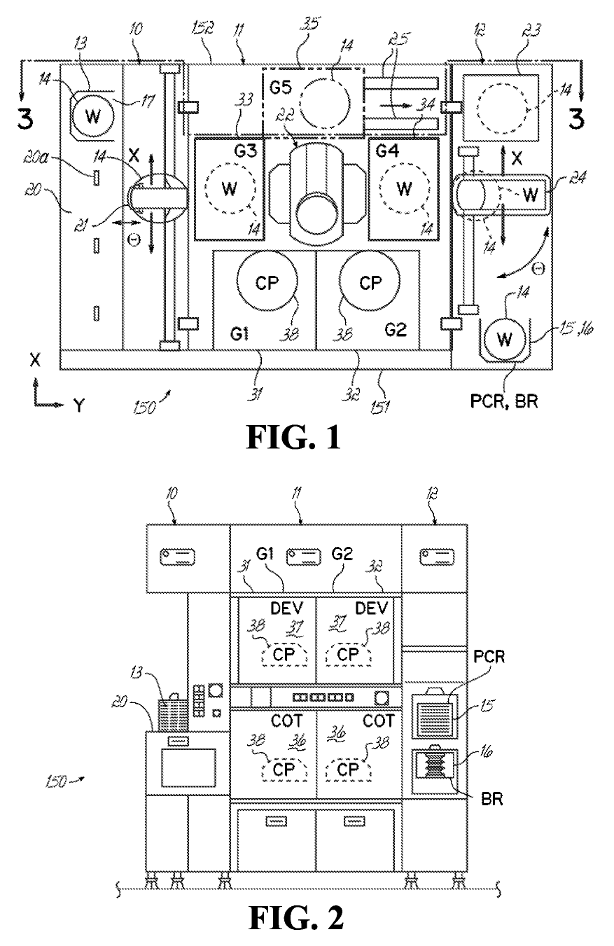

With reference to FIGS. 1-3, the coating/developing process system 150 comprises a cassette station 10, a process station 11, and an interface section 12, which are contiguously formed as one unit. In the cassette station 10, a cassette (CR) 13 storing a plurality of substrates represented by substrates (W) 14 (e.g., 25 substrates) is loaded into, and unloaded from, the system 150. Each of the substrates 14 can be composed of a semiconductor material such as silicon, which may have the form of a single crystal material of the kind used in the art of semiconductor device manufacturing.

The process station 11 includes various single-substrate processing units for applying a predetermined treatment required for a coating/developing step to individual substrates (W) 14. These process units are arranged in predetermined positions of multiple stages, for example, within first (G1), second (G2), third (G3), fourth (G4) and fifth (G5) multiple-stage process unit groups 31, 32, 33, 34, 35. The interface section 12 delivers the substrates (W) 14 between the process station 11 and an exposure unit (not shown) that can be abutted against the process station 11.

A cassette table 20 of cassette station 10 has positioning-projections 20a on which a plurality of substrate cassettes (CR) 13 (for example, at most 6) is mounted. The substrate cassettes (CR) 13 are thereby aligned in line in the direction of an X-axis (the up-and-down direction of FIG. 1) with a substrate inlet/outlet 17 facing the process station 11. The cassette station 10 includes a substrate transfer carrier 21 movable in the aligning direction (X-axis) of cassettes 13 and in the aligning direction (Z-axis, vertical direction) of substrates 14 stored in the substrate cassette (CR) 13. The substrate transfer carrier 21 gains access selectively to each of the substrate cassettes (CR) 13.

The substrate transfer carrier 21 is further designed rotatable in a θ (theta) direction, so that it can gain access to an alignment unit (ALIM) 41 and an extension unit (EXT) 42 belonging to a third multiple-stage process unit group (G3) 33 in the process station 11, as described later.

The process station 11 includes a main substrate transfer mechanism 22 (movable up-and-down in the vertical direction) having a substrate transfer machine 46. All process units are arranged around the main substrate transfer mechanism 22, as shown in FIG. 1. The process units may be arranged in the form of multiple stages G1, G2, G3, G4 and G5.

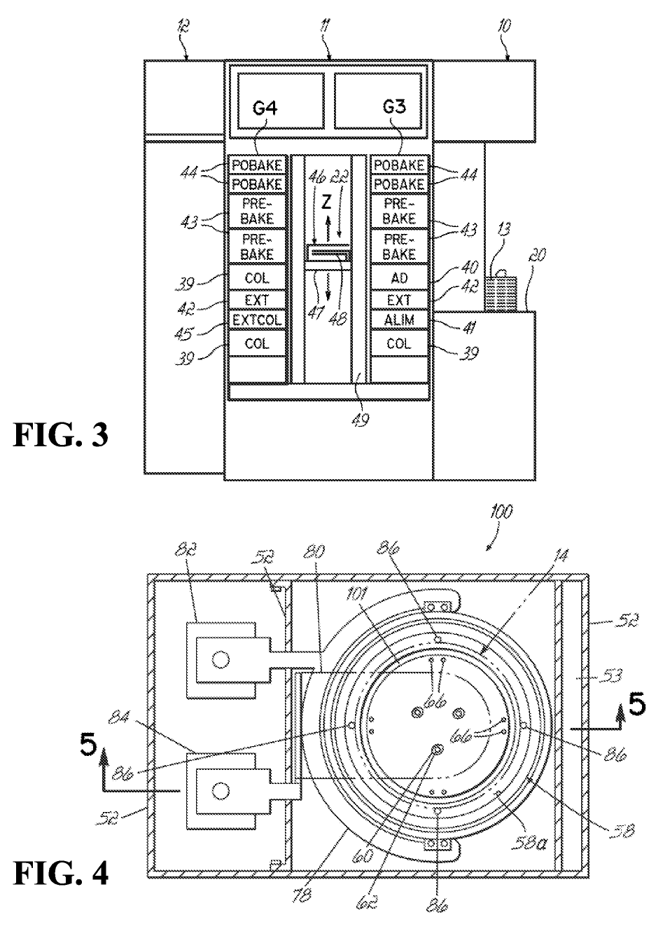

The main substrate transfer mechanism 22 has a substrate transfer machine 46 that is movable up and down in the vertical direction (Z-direction) within a hollow cylindrical supporter 49, as shown in FIG. 3. The hollow cylindrical supporter 49 is connected to a rotational shaft of a motor (not shown). The cylindrical supporter 49 can be rotated about the shaft synchronously with the substrate transfer machine 46 by the driving force of the motor rotation. Thus, the substrate transfer machine 46 is rotatable in the 0 direction. Note that the hollow cylindrical supporter 49 may be connected to another rotational axis (not shown), which is rotated by a motor.

The substrate transfer machine 46 has a plurality of holding members 48 which are movable back and forth on a table carrier 47. The substrate (W) 14 is delivered between the process units by the holding members 48.

In the process unit station 11 of this embodiment, five process unit groups G1, G2, G3, G4, and G5 may be sufficiently arranged. For example, first (G1) and second (G2) multiple-stage process unit groups 31, 32 are arranged in the front portion 151 (in the forehead in FIG. 1) of the system 150. A third multiple-stage process unit group (G3) 33 is abutted against the cassette station 10. A fourth multiple-stage process unit group (G4) is abutted against the interface section 12. A fifth multiple-stage process unit group (G5) can be optionally arranged in a back portion 152 of system 150.

As shown in FIG. 2, in the first process unit group (G1) 31, two spinner-type process units, for example, a resist coating unit (COT) 36 and a developing unit (DEV) 37, are stacked in the order mentioned from the bottom. The spinner-type process unit used herein refers to a process unit in which a predetermined treatment is applied to the substrate (W) 14 mounted on a spin chuck (not shown) placed in a cup (CP) 38. Also, in the second process unit group (G2) 32, two spinner process units such as a resist coating unit (COT) 36 and a developing unit (DEV) 37, are stacked in the order mentioned from the bottom. It is preferable that the resist coating unit (COT) 36 be positioned in a lower stage from a structural point of view and to reduce maintenance time associated with the resist-solution discharge. However, if necessary, the coating unit (COT) 36 may be positioned in the upper stage.

As shown in FIG. 3, in the third process unit group (G3) 33, open-type process units, for example, a cooling unit (COL) 39 for applying a cooling treatment, an alignment unit (ALIM) 41 for performing alignment, an extension unit (EXT) 42, an adhesion unit (AD) 40 for applying an adhesion treatment to increase the deposition properties of the resist, two pre-baking units (PREBAKE) 43 for heating a substrate 14 before light-exposure, and two postbaking units (POBAKE) 44 for heating a substrate 14 after light exposure, are stacked in eight stages in the order mentioned from the bottom. The open type process unit used herein refers to a process unit in which a predetermined treatment is applied to a substrate 14 mounted on a support platform within one of the processing units. Similarly, in the fourth process unit group (G4) 34, open type process units, for example, a cooling unit (COL) 39, an extension/cooling unit (EXTCOL) 45, an extension unit (EXT) 42, another cooling unit (COL), two pre-baking units (PREBAKE) 43 and two post-baking units (POBAKE) 44 are stacked in eight stages in the order mentioned from the bottom.

Because the process units for low-temperature treatments, such as the cooling unit (COL) 39 and the extension/cooling unit (EXTCOL) 45, are arranged in the lower stages and the process units for higher-temperature treatments, such as the pre-baking units (PREBAKE) 43 and the post-baking units (POBAKE) 44 and the adhesion unit (AD) 40 are arranged in the upper stages in the aforementioned unit groups, thermal interference between units can be reduced. Alternatively, these process units may be arranged differently.

The interface section 12 has the same size as that of the process station 11 in the X direction but shorter in the width direction. A movable pickup cassette (PCR) 15 and an unmovable buffer cassette (BR) 16 are stacked in two stages in the front portion of the interface section 12, an optical edge bead remover 23 is arranged in the back portion, and a substrate carrier 24 is arranged in the center portion. The substrate transfer carrier 24 moves in the X- and Z-directions to gain access to both cassettes (PCR) 15 and (BR) 16 and the optical edge bead remover 23. The substrate carrier 24 is also designed rotatable in the θ direction; so that it can gain access to the extension unit (EXT) 42 located in the fourth multiple-stage process unit group (G4) 34 in the process station 11 and to a substrate deliver stage (not shown) abutted against the exposure unit (not shown).

In the coating/developing process system 150, the fifth multiple-stage process unit group (G5, indicated by a broken line) 35 is designed to be optionally arranged in the back portion 152 at the backside of the main substrate transfer mechanism 22, as described above. The fifth multiple-stage process unit group (G5) 35 is designed to be shifted sideward along a guide rail 25 as viewed from the main substrate transfer mechanism 22. Hence, when the fifth multiple-stage process unit group (G5) 35 is positioned as shown in FIG. 1, a sufficient space is obtained by sliding the fifth process unit group (G5) 35 along the guide rail 25. As a result, a maintenance operation to the main substrate transfer mechanism 22 can be easily carried out from the backside. To maintain the space for maintenance operation to the main substrate transfer mechanism 22, the fifth process unit group (G5) 35 may be not only slid linearly along the guide rail 25 but also shifted rotatably outward in the system.

The baking process performed by the adhesion unit (AD) 40 is not as sensitive to warpage of the substrate 14 as are the pre- and post-bake processes performed by the prebaking units (PREBAKE) 43 and the post-baking units (POBAKE) 44. Therefore, the adhesion unit (AD) 40 may continue to utilize a hotplate in the heat treatment apparatus.

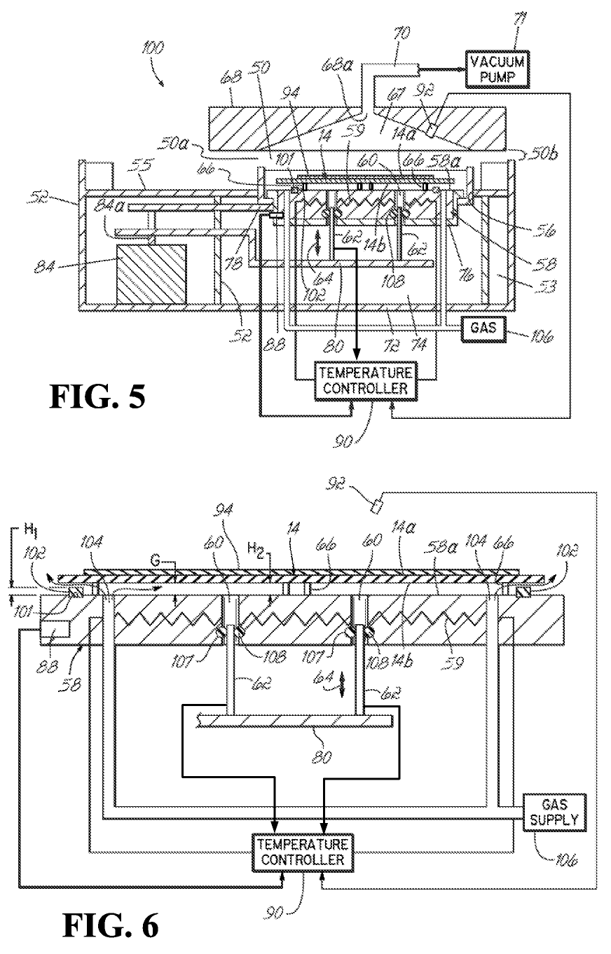

With reference to FIGS. 4 and 5, the pre-baking unit (PREBAKE) 43 or the postbaking unit (POBAKE) 44 may comprise a heat treatment apparatus 100 in which substrates 14 are heated to temperatures above room temperature. Each heat treatment apparatus 100 includes a processing chamber 50, a substrate support in the representative form of a hotplate 58, and a heating element 59 contained in the hotplate 58. The substrate 14 includes a front surface 14a (also referred to herein as the “front side”) and a rear surface 14b (also referred to herein as the “backside”).

The heating element 59 of the hotplate 58 may comprise, for example, a resistance-heating element. A temperature-sensing element 88, such as a thermistor, a thermocouple, a resistance temperature detector (RTD), or an optical fiber fluorescence decay temperature sensor may be thermally coupled with the hotplate 58. The temperature-sensing element 88, embedded in the hotplate 58 is electrically coupled with a temperature controller 90. The temperature controller 90 is also electrically coupled with the heating element 59 and powers the heating element 59 to generate heat energy used to elevate the temperature of the hotplate 58. The temperature-sensing element 88 may provide a feedback, either independently or in combination with feedback from additional temperature sensing elements, to a temperature controller 90 for optimizing the temperature setting or the uniformity of the temperature distribution across the substrate 14 supported by the hotplate 58, which may include different temperature zones.

As the heating element 59 elevates the temperature of the hotplate 58, heat energy from the hotplate 58 is conducted through the gap G, which then heats the substrate 14. The temperature of the substrate 14 may be inferred from the measured hotplate temperature or may be measured directly using a temperature sensor 92 such as, for example, a pyrometer. The temperature sensor 92, which is also electrically coupled with the temperature controller 90, may sample the temperature on a front-side 14a of the substrate 14.

The hotplate 58 has a plurality of passageways 60 and a plurality of lift pins 62 projecting into the passageways 60. The lift pins 62 are moveable between a first position, or lowered position, where the pins are flush or below the upper support surface 58a of hotplate 58 to a second position, or lifted position, where the lift pins project above the upper support surface 58a of hotplate 58. When the lift pins 62 are in the first position, they may be in contact or in close proximity to the backside 14b of the substrate 14. The lift pins 62 are connected to and supported by an arm 80 which is further connected to, and supported by, a rod 84a of a vertical cylinder 84. When the rod 84a is actuated by the vertical cylinder 84 to protrude from the vertical cylinder 84, the lift pins 62 are moved from the first position to the second position, contacting the backside 14b of the substrate 14 and thereby lifting the substrate 14.

With continued reference to FIGS. 4 and 5, the processing chamber 50 includes a sidewall 52, a lid 68, and a horizontal shielding plate 55 that defines a base with which the lid 68 is engaged. When engaged with the shielding plate 55, the lid 68 defines a process space 67 filled by a gaseous environment when lid 68 is united with the horizontal shielding plate 55. Gaps 50a, 50b are formed at a front surface side (aisle side of the main substrate transfer mechanism 22) and a rear surface side of the processing chamber 50, respectively. The substrate 14 is loaded into and unloaded from the processing chamber 50 through the gaps 50a, 50b. A circular opening 56 is formed at the center of the horizontal shielding plate 55. The hotplate 58 is housed in the opening 56. The hotplate 58 is supported by the horizontal shielding plate 55 with the aid of a supporting plate 76. The supporting plate 76, shutter arm 78, lift pin arm 80, and liftable cylinders 82, 84 are arranged in a compartment 74. The compartment 74 is defined by the shielding plate 55, two sidewalls 53, and a bottom plate 72.

A ring-form shutter (not shown) may be attached to the outer periphery of the hotplate 58. Injection openings (not shown) are formed along the periphery of the shutter at constant or varying intervals of central angles. The injection openings communicate with a cooling gas supply source (not shown). The shutter may be liftably supported by a cylinder 82 via a shutter arm 78. When the shutter is raised, a cooling gas, such as nitrogen gas or air, is exhausted from the injection openings, which is used to drop the temperature of the substrate 14 below the reaction temperature quickly while the substrate 14 is waiting to be picked up and moved to the next stage of processing. In an alternative embodiment, a cooling arm may be attached to a cooling plate that moves in when the substrate 14 is finished processing. The substrate 14 then sits on the cooling plate until it's ready to be picked up. The cooling plate may be cooled by chilled water.

The substrates 14 each carry a layer 94 of processable material, such as resist. The layer 94 may contain a substance that is volatized and released at the process temperature. The resist coating unit (COT) 36 may be used to apply the layer 94 that is thermally processed in a subsequent process step by a heat treatment apparatus 100 at the process temperature. This volatile substance evaporates off of the substrate 14 when the layer 94 is exposed to the heat energy produced by the hotplate 58 at a temperature sufficient to heat the substrate 14 and layer 94 to the process temperature. An exhaust port 68a at the center of the lid 68 communicates with an exhaust pipe 70. One or more waste products generated from the front-side 14a of the substrate 14 at the process temperature are exhausted through the exhaust port 68a and vented from the processing chamber 50 via exhaust pipe 70 to a vacuum pump 71, or other evacuation unit, that can be throttled to regulate the exhaust rate.

With reference to FIG. 4, projections 86 are arranged as alignment pins on the upper support surface 58a of the hotplate 58 and are used for accurately and reproducibly positioning the substrate 14 on hotplate 58. Support protrusions 66 define proximity pins that project from the upper support surface 58a of the hotplate 58. The support protrusions 66 bear all or a portion of the mass or weight of the substrate 14 so as to support substrate 14 during thermal processing. When the substrate 14 is mounted on the hotplate 58, top portions of the support protrusions 66 have a contacting relationship with the backside 14b of substrate 14, which is in a spaced relationship with the confronting support surface 58a on the hotplate 58. When supported on the support protrusions 66, the lift pins 62 have a contacting relationship or are in close proximity to the backside 14b. In one embodiment, the substrate 14 is flat and the backside 14b is in contact with all lift pins 62 and support protrusions 66. In another embodiment, the substrate 14 is warped and the backside 14b is in contact with one or more lift pins 62 and support protrusions 66, and in close proximity to at least one lift pin 62. In a further embodiment, the substrate 14 is misaligned relative to the hotplate 58. In this embodiment, the backside 14b may be in contact with or in close proximity to at least one lift pin 62 and support protrusions 66.

A narrow heat exchange gap G is formed between the backside 14b of the substrate 14 and the upper support surface 58a of the hotplate 58. The width of the gap G may be approximately equal to the height H2 of the support protrusions 66. The gap G prevents the backside 14b of the substrate 14 from being strained and damaged by contact with the support surface 58a on the hot plate 58.

After the substrate 14 is mounted on the hotplate 58, the gap G primarily contains a first gas, which may be a mixture of gaseous elements, such as air, or predominantly a single element, such as nitrogen. A second gas, such as hydrogen or helium, with a higher thermal conductivity than the first gas may be introduced into the gap G between the substrate 14 and the hotplate 58, to increase the thermal conductance in the gap G. Thermal conductance is the quantity of heat transmitted per unit time from a unit of surface of material to an opposite unit of surface material under a unit temperature differential between the surfaces. As the high thermal conductivity gas is introduced into the gap G, it displaces the first gas causing the first gas to flow out of the gap G. A loose seal may be formed between a sealing member 102, such as an o-ring (FIG. 6), and the rear surface 14b of the substrate 14. The sealing member 102 assists in keeping the high thermal conductivity gas contained in the gap G and inhibits any reentry of the first gas back into the gap G.

Heat energy from the hotplate 58 is conducted through the high thermal conductivity gas in the gap G to the substrate 14. The thermal conductivity represents a measure of material to conduct heat. The thermal conductivity of the material forming the substrate 14 is sufficient to transfer heat from the backside 14b to the front-side 14a of the substrate 14. The higher thermal conductivity of the gas makes the system less sensitive to warpage in the substrate 14 by compensating for variations in flatness that modulate the width of gap G. For example, a system with air in the gap G between the substrate 14 and the hotplate 58 may produce about a 1° C. temperature gradient in different parts of the substrate 14 due to warpage. The temperature gradient may be reduced to about 0.17° C. (about 0.31 degree Fahrenheit) by replacing the air, or other low conductivity gas, in the gap G with the high thermal conductivity gas such as helium, which has a thermal conductivity of almost six times greater than the thermal conductivity of air.

The hotplate 58 further includes a groove 101 in the hotplate 58 and a sealing member 102, such as an o-ring, placed in the groove 101, as best shown in FIG. 6. The substrate 14 is delivered to the processing chamber 50, as discussed above, and lift pins 62 lower the substrate 14 as shown diagrammatically by arrow 64 (FIG. 5). The substrate 14 is guided into position by projections 86 in proximity to the sealing member 102 and is supported above the hotplate 58 on support protrusions 66 where the backside 14b of the substrate 14 contacts a top of the support protrusions 66. The height Hi of the sealing member 102 relative to the upper support surface 58a of hotplate 58 may be slightly shorter than the height H2 of the support protrusions 66 to assist the high thermal conductivity gas in displacing the air, or other low thermal conductivity gas, in the gap G. The difference in height Hi and height H2 results in a loose seal or dam being formed between an outer perimeter of the substrate 14 and the sealing member 102 as best seen in FIG. 6. The loose seal allows gases from the gap G between the substrate 14 and the hotplate 58 to escape from beneath the substrate 14 by passing between the sealing member 102 and the substrate 14, while inhibiting gases from the processing chamber 50 from moving back into the gap G.

The high thermal conductivity gas is introduced into gap G through delivery passageways 104 in the hotplate 58. The delivery passageways 104 communicate with a high thermal conductivity gas supply 106. The air, or other low thermal conductivity gas, in the gap G is displaced as the high thermal conductivity gas from the gas supply 106 is delivered into the gap G. The resulting gaseous environment in the gap G between the backside 14b of the substrate 14 and upper support surface 58a of the hotplate 58 is primarily composed of the high thermal conductivity gas, which increases the thermal conductance in the gap G. The high thermal conductivity gas need not displace all of the air in the gap G. However, a gaseous environment in the gap G containing higher concentrations of the high thermal conductivity gas than air, or other low thermal conductivity gas, will promote greater heat transfer and thermal conductance between the hotplate 58 and the substrate 14. In alternate embodiments, the delivery passageways 104 may supply a continuous flow of high thermal conductivity gas to displace the air in the gap G. The continuous flow of the high thermal conductivity gas prevents air, or other low thermal conductivity gas, from re-entering and filling the gap G.

Each of the passageways 60 includes a ring-shaped groove 107 in a sidewall surrounding each passageway 60 and a seal member 108 in the groove 61 that creates a pressure seal between one of the lift pins 62 and its respective passageway 60 at least when the lift pins 62 are retracted into the hotplate 58 to the first position. The seal members 108 prevent or significantly restrict the flow of the high thermal conductivity gas through the passageways 60 and out of the gap G. Likewise, sealing the passageways 60 inhibits the flow of air back into the gap G. Alternatively, each of the lift pins 62 may carry a seal member (not shown) that provides a seal with the corresponding passageway 60 as a substitute for seal members 108.

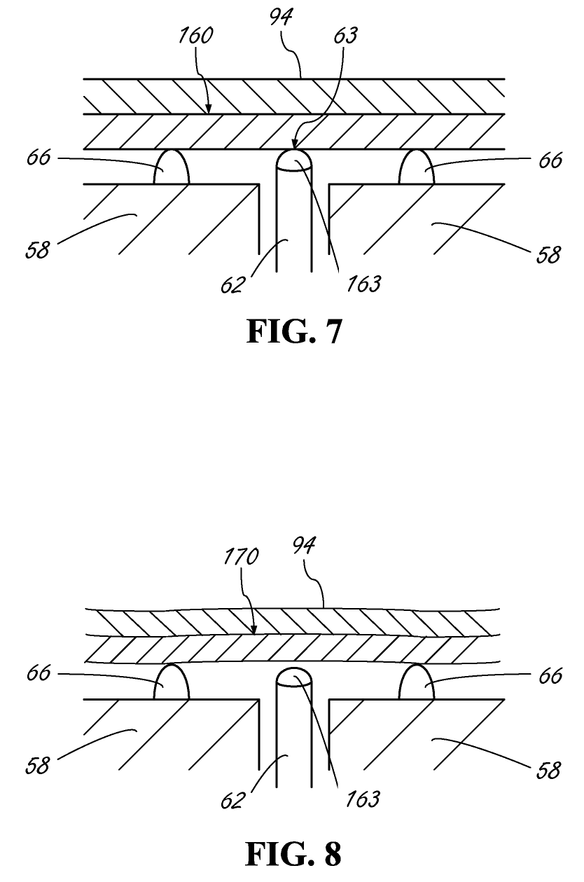

FIG. 7 is an illustration of a flat substrate 160 in contact at a temperature sensor contact point 63 with support protrusions 66 and a lift pin 62 configured with a temperature sensor 163. In another embodiment (not shown), a plurality of lift pins 62 each configured with a temperature sensor 163, are used to measure a temperature at various contact points 63 across the surface of the flat substrate 160. Each temperature sensor 163 may be a thermocouple, a thermistor, a resistance temperature detector, a fiber optic fluorescence decay temperature sensor, or another temperature sensing device configured to measure a contact temperature, or surface temperature of the substrate measured through conduction.

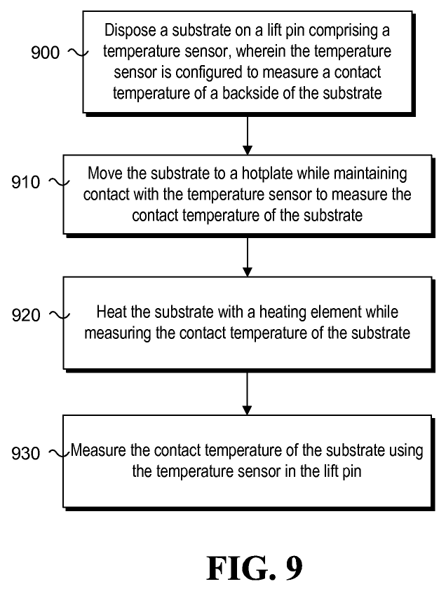

The lift pin 62 configured with a temperature sensor 163 may support at least a portion of the flat substrate 160 when the flat substrate 160 is disposed on support protrusions 66. A temperature controller 90 controls a temperature of the heating element based, at least in part on a temperature measured by each temperature sensor 163. The temperature controller 90 may determine that a substrate 14 is flat and properly placed on the hotplate 58 when all lift pins 62 configured with temperature sensors 163 sense a temperature within an expected range. For example, when all temperature sensors 163 measure a process temperature ranging from about 90° C. to about 130° C., it may indicate that the substrate 14 is flat and properly placed on the hotplate 58. In another example where the substrate 14 is misaligned relative to the hotplate or where the substrate is warped, a temperature sensor 163 in close proximity to the backside 14b may provide a process temperature below an expected temperature range. For example, a process temperature measured by a temperature sensor 163 in close proximity to a misaligned substrate (not shown) or a warped substrate (FIG. 8) may be below 90° C.

FIG. 8 is an illustration of a warped substrate 170 in contact with support protrusions 66 and in close proximity to a lift pin 62 configured with a temperature sensor 163. In this embodiment, the lift pin 62 configured with a temperature sensor 163 does not support, in whole or in part, the flat substrate 160 when the warped substrate 170 substrate 160 is disposed on support protrusions 66. The temperature controller 90 may determine that a substrate 14 is warped and/or improperly placed on the hotplate 58 when all lift pins 62 configured with temperature sensors 163 do not sense a temperature within an expected temperature range. For example, when all temperature sensors 163 do not measure a process temperature ranging from about 90° C. to about 130° C., the temperature controller 90 may indicate that the substrate 14 is warped and/or improperly placed on the hotplate 58.

FIG. 9 presents a method of monitoring a temperature of a substrate 14 on a hot plate 58 using a plurality of lift pins 62 configured with temperature sensors 163. In element 900, a substrate 14 is disposed on a lift pin 62 comprising a temperature sensor 163, wherein the temperature sensor 163 is configured to measure a contact temperature of a backside of the substrate 14. In element 910, the substrate 14 is moved to support protrusions 66 of a hotplate 58 while maintaining contact with the temperature sensor 163 to measure the contact temperature of the substrate 14. In element 920, the substrate 14 is heated with a heating element 59 while measuring the contact temperature of the substrate 14. In element 930, the contact temperature of the substrate 14 is measured with the temperature sensor 163 in the lift pin 62. The contact temperature of the lift pin 62 may be directed to the temperature controller 90. The temperature controller 90 may monitor and control the temperature of the heating element 59 using data collected from one or more lift pins 62, the temperature-sensing element 88, other temperature sensors, or some combination thereof.

A plurality of embodiments for forming very thin layers on surfaces resulting in a film with a consistent or desired thickness profile has been described. The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate or upper layer is the “top” surface of that substrate; the substrate may actually be in any orientation so that a “top” side of a substrate may be lower than the “bottom” side in a standard terrestrial frame of reference and still fall within the meaning of the term “top.”

The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

1. A method for monitoring a process temperature, the method comprising:
disposing a substrate on a lift pin, the lift pin comprising a temperature sensor, wherein the temperature sensor is configured to measure a contact temperature of the substrate;
moving the substrate to a hotplate, the hotplate having support protrusions configured to support the substrate in a spaced relationship with the hotplate to define a heat exchange gap between the hotplate and the substrate;
heating the substrate through the heat exchange gap; and
measuring the contact temperature with the lift pin.

2. The method of claim 1, further comprising:
heating the hotplate to a first temperature above room temperature; and
heating the substrate to a second temperature above room temperature.

3. The method of claim 1, wherein the substrate is supported by the support protrusions and the lift pin.

4. The method of claim 1, wherein the substrate includes a front-side opposite to a backside and a layer of a processable material carried on the front-side, and heating the processable material in the layer to the process temperature ranging from about 90° C. to about 130° C.

5. The method of claim 4, wherein the substrate carries a layer for thermal processing, and further comprising:
generating a waste product when the layer carried on the substrate is heated to a process temperature; and
removing at least part of the waste product.

6. The method of claim 1, further including supporting the substrate in part by a plurality of lift pins, wherein each lift pin comprises a temperature sensor.

7. The method of claim 1, further including heating the substrate in response to the contact temperature.

8. A method for detecting a misaligned substrate, the method comprising:
disposing the substrate on a lift pin, the lift pin comprising a temperature sensor, wherein the temperature sensor is configured to measure a contact temperature of the backside of the substrate;
moving the substrate to a hotplate, the hotplate having support protrusions configured to support the substrate in a spaced relationship with the hotplate to define a heat exchange gap between the hotplate and the substrate;
heating the substrate through the heat exchange gap;
measuring the contact temperature with the lift pin; and
determining if the contact temperature is within an expected temperature range.

9. The method of claim 8, wherein the expected temperature range is between 90° C. to about 130° C.

10. A method for detecting a warped substrate, the method comprising:
disposing the substrate on a lift pin, the lift pin comprising a temperature sensor, wherein the temperature sensor is configured to measure a contact temperature of the backside of the substrate;
moving the substrate to a hotplate, the hotplate having support protrusions configured to support the substrate in a spaced relationship with the hotplate to define a heat exchange gap between the hotplate and the substrate;
heating the substrate through the heat exchange gap;
measuring the contact temperature with the lift pin; and
determining if the contact temperature is within an expected temperature range.

11. The method of claim 10, wherein the expected temperature range is between 90° C. to about 130° C.
